(19) United States
(12) Patent Application Publication
(10) Pub. No.: US 2001/0056399 A1
(43) Pub. Date: Dec. 27, 2001

(54) Web dependent consumer financing and virtual reselling method

(76) Inventor: Eric Saylors, Lake Oswego, OR (US)

Correspondence Address: MILLER NASH LLP, ATTN: KAREN DANA OSTER, 111 S.W. FIFTH AVENUE, SUITE 3500, PORTLAND, OR, 97204-3699, US

(21) Appl. No.: 09/894,644

(22) Filed: Jun. 27, 2001

Related U.S. Application Data
(60) Provisional application No. 60/214,088, filed on Jun. 27, 2000.

(51) Int. Cl. G06F 17/60

(52) U.S. Cl. 705/38

(57) ABSTRACT

A Virtual Reseller Credit Program implemented, at least in part, over a electronic communication media that includes an employed customer seeking to finance the purchase of a product, an employer, a lender, and a credit-risk reducer that may be credit insurance or a recourse reserve fund. The lender's decision to fund the employed customer may be based, at least in part, on the employed customer's employment (and the employer's agreement to use automatic payroll deductions) and/or the presence of the credit-risk reducer. In one preferred embodiment of the invention, a virtual reseller is used to order and deliver, sometimes using third parties, the product on behalf of the employed customer. The virtual reseller may also monitor repayment of the credit and automatically detect late payments.

The present application is based on, and claims priority from, provisional application Ser. No. 60/214,088, filed Jun. 27, 2000.

### BACKGROUND OF THE INVENTION

The present invention relates to a process for financing, and more particularly to a consumer financing and virtual reselling method.

As the Information Age dawns, America's economy is becoming ever more knowledge-based. For young people seeking position and success in the marketplace, computer proficiency and electronic communications medium access are vital. But there is a problem. While nearly every business in the world has adopted the personal computer, the United States consumer market is “stuck” at approximately 52% penetration. This statistic means that approximately half of the households in the United States do not have access to a home computer or the Internet. The “digital divide” is the international buzzword for this phenomenon.

Minorities make up a disproportionate number of those without home computers. Despite plummeting computer prices, a gap is growing between white and minority households with personal computers. The social implications of this trend, if left unchecked, are ominous. This condition could ultimately create a whole class of information-deficient “have-nots” who will be unable to compete or advance in new job markets.

Although a variety of factors may contribute to the digital divide, studies confirm that the major contributing factor is financial. All major personal computer makers offer various consumer finance and leasing programs to expand their markets to those that prefer or can afford monthly payments instead of a cash purchase. Lenders that provide the funds for these programs routinely reject 60% of the applicants. Each month, approximately 100,000 customers are declined credit for a consumer loan or personal lease to acquire a new personal computer. Most of those denied credit are working Americans who can afford installment payments, but they are denied traditional credit for a variety of circumstances and a singular reason. Credit analysis is rigid; it classifies people in only two categories: “Good-creditworthy” or “no credit.” This approach to credit contributes to the widening gap between those on either side of the digital divide.

Online retailers currently supply some alternatives to personal computer purchases, but do not generally address the under-served and those with limited credit access. For instance, PeoplePC.com (“PPC”) offers a basic Intel/Windows personal computer, Internet access, limited onsite warranty, and technical support for $24.95 per month. PPC replaces the computer every three years. However, PPC customers must supply a credit card for the monthly payment and are traditional creditworthy individuals.

Finding more aggressive lenders apparently cannot solve this problem. At least one major personal computer maker, Gateway, Inc., introduced a program using a consumer lender that accepted higher credit-risk customers in exchange for a higher, variable interest rate (up to 26 percent). Even under this program, many customers were denied credit.

Large companies have been known to give key employees computers as “perks.” Usually the computer offered is a specific “one-size-fits-all” computer. This perk system has significant flaws. The “one-size-fits-all” computer usually does not provide enough computing power for users of more advanced applications and sometimes provides too much computing power (or is too complicated) for other users. Further, the perk may not be attractive for employees who already have a computer. Still further, many companies limit the perk to certain key employees, thereby omitting those employees who could use a computer most.

Today automatic payroll deductions are universal for withholding taxes and widely used to pay for everything from insurance, union dues, charitable contributions, 401K, and other savings/investment plans. In fact, payroll deduction is the most reliable, convenient, and “painless” way for a consumer to pay a bill. The authors of the Tax Act of 1942 instituted tax withholding because it is easier to collect taxes from employers than it is to collect from individual taxpayers. This method of collecting taxes is extremely reliable, with compliance among employers approaching 100 percent. No one has yet realized the potential of using the existing electronic communication media for automatic payroll deductions and broad-based consumer acceptance of this payment method to create a more efficient consumer finance model.

Some employers have begun to recognize that payroll deductions can be used to allow a worker to pay for computers. These visionary employers allow their employees the convenience of using payroll deductions and, in exchange, get computer-literate employees. These programs, however, are complicated and require the employers to develop specific policies and procedures. Further, if the employee quits, dies, is fired, or otherwise leaves the employer's company, the employer runs a high risk of never being paid back. These problems are enough to prevent most employers from implementing such programs.

Some finance companies have started to offer programs by which employers can offer their employees credit cards that are paid using payroll deductions. The employer who chooses to offer this benefit is, in effect, offering a perk. The employee benefits from the easy payment and, in some cases, may pay interest at a reduced rate. However, if the employee quits, dies, is fired, or otherwise leaves the employer, either the money due is deducted from the employee's last check, the employer is left with the debt, or the finance company offering the service is left with the debt.

### BRIEF SUMMARY OF THE INVENTION

The present invention offers a new type of consumer financing that results in universal access to consumer credit for reliable workers. Specifically, in one preferred embodiment, the invention offers a new model for consumer financing of any product. For example, relying upon electronic communication media and the use of virtual resellers, the method of the present invention results in efficiencies that make credit enhancement viable for every customer. Credit enhancement may be provided by credit-risk reducing features such as insurance or a recourse reserve fund.

Specifically, the present invention is directed to a Virtual Reseller Credit Program preferably implemented, at least in part, over a electronic communication media that includes at least one employed customer seeking to finance the purchase of a product, at least one employer employing the employed customer, at least one lender for granting credit in the amount of the cost of the product to the employed customer, and at least one credit-risk reducer for providing the at least one lender repayment of the credit to the employed customer in the event of a default. In one preferred embodiment, at least a portion of the cost of the product is used to fund the credit-risk reducer which may be credit insurance or a recourse reserve fund.

The lender's decision to fund the employed customer may be based, at least in part, on the employed customer's employment (and the employer's agreement to use automatic payroll deductions) and/or the presence of the credit-risk reducer.

In one preferred embodiment of the invention, a virtual reseller is used to receive an order for the product on behalf of the employed customer. The virtual reseller may then purchase the product from a manufacturer. Finally, a distributor ships the product to the employed customer. The virtual reseller may also monitor repayment of the credit and automatically detect late payments.

The invention provides an important public benefit by providing a credit guarantee for employed individuals that have the ability to pay but who do not have access to traditional credit.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWING

FIG. 1 is a schematic diagram of an exemplary setup and service process using the Virtual Reseller Credit Program of the present invention.

FIG. 2 is a schematic diagram of an exemplary first preferred embodiment of a job change process using the Virtual Reseller Credit Program of the present invention.

FIG. 3 is a schematic diagram of an exemplary second preferred embodiment of a job change process using the Virtual Reseller Credit Program of the present invention.

FIG. 4 is a schematic diagram of an exemplary loan process using the Virtual Reseller Credit Program of the present invention.

FIG. 5 is a schematic diagram of an exemplary additional product purchase process using the Virtual Reseller Credit Program of the present invention.

FIG. 6 is a schematic diagram of an exemplary loan default process using the Virtual Reseller Credit Program of the present invention.

FIG. 7 is a schematic diagram of an exemplary insurance coverage process using the Virtual Reseller Credit Program of the present invention.

FIG. 8 is a schematic diagram of an exemplary employed customer update process using the Virtual Reseller Credit Program of the present invention.

FIG. 9 is a schematic diagram of an alternate preferred embodiment of the Virtual Reseller Credit Program of the present invention.

### DETAILED DESCRIPTION OF THE INVENTION

The present invention is a “Virtual Reseller Credit Program” for financing the purchase of consumer products that uses automatic payroll deductions, a credit-risk reduction feature such as insurance or a recourse reserve fund, and preferably a virtual reseller of the consumer products. One preferred embodiment of the present invention exploits efficiencies made available through electronic communications media such as the Internet, the World Wide Web, and other electronic data interchanges (“EDI”). The invention facilitates the grant of credit to purchase personal computers and other products to customers who are employed but are unable to qualify for traditional credit or just prefer the convenience and security of the Virtual Reseller Credit Program.

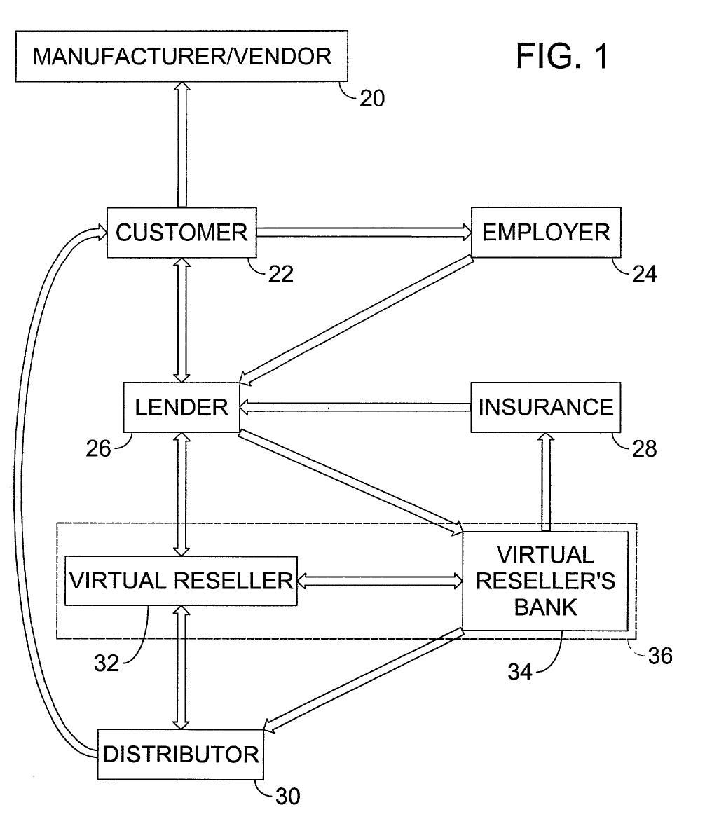

As shown in FIGS. 1-8, the present invention preferably uses an electronic communications medium to create a virtual environment in which manufacturers 20, employed customers 22, employers 24, lenders 26, insurance or other credit-risk reducers 28, and distributors 30 are connected through a centralized finance and payment database maintained, for example, by a virtual reseller 32. A virtual reseller's bank 34 may be used in the implementation of the present invention. Each of the entities and some of the benefits to each of them will be examined individually. Manufacturers or vendors 20 may be any producer or supplier of consumer products (e.g. an original equipment manufacturer (“OEM”), wholesalers, retailers, importers, and direct sellers). To facilitate understanding of the invention, however, the manufacturer 20 is being described in terms of manufacturers 20 that sell computers, software, and peripherals, such as Apple Computer, Inc., Compaq Computer Corporation, Dell Computer Corporation, Gateway, Inc., Micron Technology, Inc., Hewlett Packard Company, International Business Machines Corporation (IBM), Sony Corporation, Toshiba Corporation, Acer Incorporated, Seiko Epson Corporation, Cannon Inc., and Microsoft Corporation. Many of these manufacturers 20 have web sites in which they offer their products to employed customers 22 along with some type of financing. The manufacturer 20 or a third party lender 26 may provide the financing. As mentioned, however, many employed customers 22 do not qualify for traditional financing.

The Virtual Reseller Credit Program of the present invention will provide manufacturers 20 with an expanded market for their products, because a majority of American workers will qualify for the Virtual Reseller Credit Program. Further, if the manufacturer 20 functions as an employer 24, lender 26, provider of insurance 28, distributor 30, virtual reseller 32, or other participant in the process it will reap the additional benefits associated with that function. For example, in one preferred embodiment of the present invention, manufacturer employers would be the first to present the Virtual Reseller Credit Program to their employees. Offering the Virtual Reseller Credit Program to these employees would create an immediate supply of employed customers 22 for the Virtual Reseller Credit Program of the present invention.

Employed customers 22 may be any person or entity desirous of purchasing products. In most situations the employed customer will be an individual employed by a company. However, corporations, charities, or small businesses could arrange to make automatic monthly payments of a predetermined amount to purchase products. It should be noted that the present invention could also be implemented using automatic payment from a credit card or from a bank account.

An exemplary employed customer 22 who desires to purchase a personal computer would have a variety of ways to choose the desired specific personal computer. For example, the employed customer 22 may visit the manufacturer's 20 web site, the virtual reseller's 32 web site (that could provide original content or links to manufacturers 20), or a distributor's 30 web site. The employed customer 22 selects the specific personal computer and then selects the Virtual Reseller Credit Program financing options.

The Virtual Reseller Credit Program provides a number of benefits to employed customers 22 including an automated and “painless” method of purchasing products. Employed customers 22 do not need to open bills and write checks every month. It is probable that most employed customers 22 are less reliable in paying their bills than in going to work. Interest rates charged to employed customers 22 are likely, in one preferred embodiment, to be lower than those that are usually charged by lenders willing to grant credit to individuals with impaired credit records because the automatic payment feature reduces credit default risks and the insurance 28 feature provides a payment guarantee.

The employer's 24 role in the Virtual Reseller Credit Program is basically to assume responsibility, without liability, for making automatic payroll deductions of installment payments of credit granted to an employed customer 22. Almost all employers 24 have the capability to make automatic payroll deductions. The employer 24, however, can assume an expanded role by offering the Virtual Reseller Credit Program as a benefit to their employees. Further, the employer 24 can offer the additional benefit of subsidizing the payments made under this program. The employer 24 might even take on other functions such as serving as the lender 26.

Employers 24 know that the majority of their employees are reliable. These employees are at work, on time, day in and day out. Most employees never voluntarily leave their jobs unless a better job becomes available.

Employers 24 also know that supporting their employees with a variety of employee benefits can improve employee retention, morale, and productivity. Employers 24 are likely to view the Virtual Reseller Credit Program as a positive benefit they can offer employees. Simply by agreeing to make payroll deductions available to employees who wish to participate in the Virtual Reseller Credit Program, employers 24 will be enhancing the ability of employees to purchase products they want and need. The enhanced availability of credit is likely to be viewed by employees as a significant benefit of employment, giving participating employers 24 a competitive edge in hiring and retention.

Some employers 24 may wish to go further, and contribute a bonus or subsidy such as some percentage of the employee's earnings, some percentage of the employer's profits, or a flat amount to repayment of credit granted under the Virtual Reseller Credit Program. This type of arrangement is particularly likely if the employer 24 believes that encouraging the purchase of personal computers or similar products will improve employee job skills.

It should be noted that in one preferred embodiment of the present invention the employer 24 is not required to “sign-up” for the Virtual Reseller Credit Program. Instead, the employer 24 is only asked to agree to make the automatic payroll deductions and transmit deducted funds to the appropriate party 26, 32.

Generally a lender 26 specifically agrees to participate with a virtual reseller 32 in the Virtual Reseller Credit Program. However, the function of the lender 26 may be implemented by several of the other parties of the program (e.g. manufacturers 20, employers 24, or the virtual reseller 32). Retail sellers or lease program coordinators may also elect to act as a lender 26. Lenders 26 that provide private label consumer credit grants for manufacturers 20 can use the Virtual Reseller Credit Program as second-tier funding for their employed customers 22. These private label lenders 26 are already collectively generating up to 100,000 customers 22 each month that will qualify for Virtual Reseller Credit Program credit grant. The present invention is sufficiently flexible to provide the desired benefits regardless of which entity acts as a lender 26 or otherwise elects to grant credit.

The lender 26 may analyze an employed customer's 22 credit application to confirm that the employed customer 22 meets the qualifications for participation in the Virtual Reseller Credit Program. Preferably the lender will be looking at the behavioral profile of the employee (such as the predetermined time required for employment). Alternatively, the credit analysis can be accomplished using traditional credit-scoring criteria adjusted to take into account the reduced credit risk to the lender 26 resulting from the features of the Virtual Reseller Credit Program. These methods of credit analysis are well known in the financial services industry, and each lender 26 is likely to apply criteria that reflect the lender's own credit risk preferences. Nevertheless, it is expected that the credit-risk reduction features of the Virtual Reseller Credit Program will result in approval of the vast majority of credit requests from employed customers 22, even those who cannot qualify for traditional credit.

Lenders 26 benefit from the reduction in credit risks provided by automatic payroll deductions and mechanisms to provide for payment of the debt in case of default. Lenders 26 also benefit from a reduction of processing costs because payments may be processed electronically as opposed to manually. Customer acquisition costs are also reduced because the employed customer 22 does the actual data entry. If an employer 24 consolidates payments (if the employer 24 has multiple employees participating in the Virtual Reseller Credit Program) there is a further reduction of costs.

One key component of the Virtual Reseller Credit Program of the present invention is insurance or other credit-risk reducers 28. Credit-risk reducers 28 may include a specific insurance coverage plan and/or a recourse reserve fund. The credit-risk reducers 28 are used to guarantee credit for all of the virtual reseller's customers including those that otherwise would not qualify for traditional credit. The credit-risk reducers 28 are funded from profits realized from the efficiencies of the reselling method. The insurance policy can provide for payment of credit in case of the borrower's death, disability, termination of employment, or default.

One preferred embodiment of a credit-risk reducer 28 is an insurance 28 program in which part of the proceeds of each loan are paid to an insurer to purchase credit insurance for the loan. Readily available credit insurance products are sold covering a variety of risks. Credit insurance can be purchased covering those risks most likely to affect the ability of an employed customer 22 to repay the debt, including death, disability, and unemployment. Under one alternate embodiment of the Virtual Reseller Credit Program, credit insurance is purchased to insure against any default in repayment of the debt.

An alternative or additional credit-risk reducer 28 involves a charitable foundation to provide a recourse reserve fund or insurance premium payments. Elimination of the digital divide is generally seen as a goal that will benefit all citizens and will help to decrease disparities between different segments of society in terms of education and earning power. As a result, personal computer manufacturers 20 and existing grant-making organizations may be willing to support the Virtual Reseller Credit Program through tax-deductible, charitable contributions. A charitable foundation can therefore be made a part of the Virtual Reseller Credit Program to receive these contributions. Contributions could be used to fund part or all of the recourse reserve fund or credit insurance policies 28 that reduce the credit risk for lenders 26 participating in the Virtual Reseller Credit Program.

The costs of insurance or a recourse reserve fund 28 may be paid, for example, from the difference between the price charged to the employed customer 22 and the wholesale product price charged by the distributor 30. Because of the efficiencies realized by the virtual reseller 32, it will usually be possible to cover these costs for the normal difference between the wholesale price charged by the distributor 30 and the amount charged by the virtual reseller 32 to the employed customer 22. In addition, the virtual reseller 32 may be able to participate in co-operative advertising rebate programs that provide resellers with a credit for advertising, often in the form of product price discounts. These discounts may provide further revenue from which credit-risk reduction costs can be paid.

As will be discussed, the credit-risk reducers 28 may advance payments if the payment is late by a predetermined number of days. However, notice is sent by email, postal mail, or telephone to the employed customer 22 and/or the employer 24, if a payment is late. A default process can then be instituted, if the loan is in default, in accordance with standard commercial practices.

Credit-risk reducers 28 have the effect of reducing the risk borne by the lender 26, allowing the lender 26 to extend credit to employed customers 22 who would otherwise not qualify and reducing credit costs to employed customers 22. Ultimately this would allow credit to be granted to the majority of employed workers.

Distributors 30 are used to deliver products to the employed customer 22. In some cases distributors 30 may also offer web sites to attract customers 22. In some cases, the manufacturer 20 and the distributor 30 may be a combined entity (not shown). Examples of this combined entity might be Dell Computer Corporation and Gateway, Inc. There may also be additional intermediaries between the manufacturer 20, employed customer 22, distributor 30, and virtual reseller 32.

Central to the present invention is a virtual reseller 32. The virtual reseller 32 monitors installment payment flow and automatically detects late payments. The monitoring function may be performed by specially developed operating architecture or computer programs. Detection of a late payment triggers an early inquiry in the form of electronic (e.g. e-mail), telephone, postal, or in-person inquiries to the employed customer 22 and/or to the customer's employer 24. If a payment past due and the appropriate steps (e.g. ascertained the nature of the payment interruption and determined that the interruption is an insured event) have been taken, the credit-risk reducer 28 makes the payment for the customer 22.

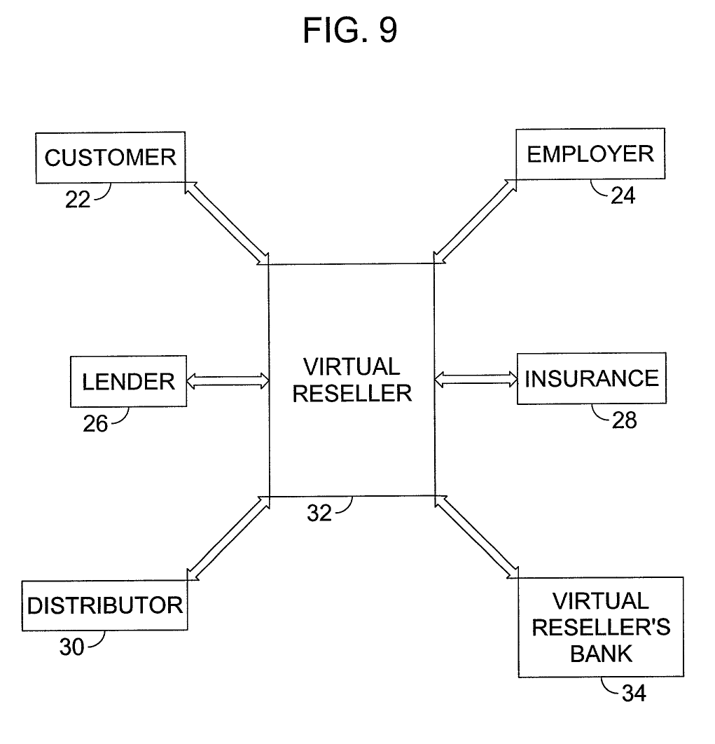

There are several alternative preferred embodiments relating to the virtual reseller 32. For example, the virtual reseller 32 and virtual reseller's bank may be implemented as a single, self-funded entity 36 as shown in FIG. 1. In another alternative embodiment of the present invention the virtual reseller 32 could be eliminated if another party or parties take over crucial virtual reseller 32 functions. Although the embodiments of FIGS. 1-8 show the virtual reseller 32 being included in only some aspects of the present invention, the virtual reseller may create and maintain the entire Virtual Reseller Credit Program. Further, as shown in FIG. 9, in one alternative embodiment of the present invention the virtual reseller 32 provides a method for reselling any product without inventory, returns, or the need to provide support or product service to the employed customer 22. The virtual reseller 32 purchases the product for resale only when the virtual reseller 32 sells the product to the employed customer 22. A third party, usually the distributor 30, ships the product directly to the employed customer 22.

There are several advantages for the virtual reseller 32 format as compared to the traditional sells formats. The virtual reseller 32 purchases product only after receiving a purchase order from the lender 26 on behalf of the employed customer 22. The virtual reseller 32 maintains no inventory, avoiding the overhead associated with a traditional reseller's business. The distributor 30 deals with the employed customer 22 with respect to product returns, technical support, or any other services needed. The virtual reseller 32 assumes no credit risk, because all sales are for cash, provided by the lender 26.

The virtual reseller's bank 34, functions primarily to send and receive payments at the direction of the virtual reseller 32. Payments directed to the virtual reseller 32, in this embodiment, would actually be directed to the virtual reseller's bank 34. Payments requested by the virtual reseller 32, in this embodiment, would actually be made by the virtual reseller's bank 34 at the direction of the virtual reseller 32. As mentioned, the virtual reseller's bank 34 may be combined with the virtual reseller 32 so that they function as a single, self-funded entity 36 as shown in FIG. 1.

Although the present invention exploits efficiencies made available through electronic communications media such as the Internet, the World Wide Web, and other electronic data interchanges, certain steps or alternate embodiments could be conducted using more traditional methods including postal delivery, hand delivery, telephone calls, and facsimile. For example, it is possible that communications between an employed customer 22 and his or her employer 24 will be in person. It is also possible that certain documentation may be sent via postal mail or facsimile (such as original signed documents). Still further, the virtual reseller 32 may contact the customer 22 or employer 24 by telephone. Accordingly, electronic communications media can be further defined to include these and other alternative communication methods.

Many of the aspects of the Virtual Reseller Credit Program depend on the efficiency of effecting transactions via electronic communications media. Online credit applications give employed customers 22 the satisfaction of fast transaction completion and credit decisions, while lowering application data entry costs for lenders 26. The ability to communicate via electronic communications media with the virtual reseller 32 allows lenders 26 to offer the Virtual Reseller Credit Program as their own, private-labeled second tier financing program, so that lenders 26 who prefer to do so can have the Virtual Reseller Credit Program appear to be part of their own financing programs. The automatic referral to the Virtual Reseller Credit Program of employed customers 22 who do not meet a lender's 26 requirements for traditional credit provides the Virtual Reseller Credit Program with a ready-made market at low or no cost. Electronic transmission of all records and payments among participating organizations reduces transaction costs. The transmission of payments electronically to the lender 26 facilitates payment monitoring by the virtual reseller 32. E-mail or other electronic communications media communication to the customer 22 or employer 24 regarding late payments enhances the likelihood that defaults can be avoided or promptly cured.

Turning now to an exemplary embodiment of the present invention as shown in FIGS. 1-8, it should be noted that this is an exemplary method and many alternative embodiments are possible. For example, many of the parties may be combined or divided into multiple parties. Also, it is possible that information may travel through alternate parties. For example, as shown in FIG. 9, all information may travel through the virtual reseller 32.

FIG. 1 shows a basic setup and service process of the present invention. In this embodiment, the employed customer 22 selects products at participating manufacturer's 20 online store and picks the Virtual Reseller Credit Program as a financing option. Next, the employed customer 22 submits a loan application at the lender's 26 web site (which may be linked to the manufacturer's 20 web site). The lender 26 then approves the loan and sends loan documents to the employed customer 22 via an electronic communication media. The employed customer 22 may print out the loan documents (or use electronic mechanisms), take documents to his or her employer's 24 human resources department, and request payroll deduction. The employed customer 22 then mails signed loan documents to the lender 26. Substantially simultaneously, the employer 24 completes the employer's portion of the online loan application form providing bank routing number, employee verification, and other pertinent information to the lender 26. The lender 26 then sends an approved purchase order and supporting information to the virtual reseller 32. Upon receipt, the virtual reseller 32 sends a purchase order to the distributor 30 who ships the product to the employed customer 22. The distributor 30 then sends a shipping confirmation and requests payment from the virtual reseller 32. The virtual reseller 32 notifies the lender 26 that the product has been shipped, and requests payment. The lender 26 then funds the loan, to satisfy virtual reseller's purchase order and, upon receipt of funds, the virtual reseller's bank 34 notifies the virtual reseller 32 that the loan has been funded. The virtual reseller 32 then sends instructions to the bank 34 to pay the distributor 30 and the credit-risk reducer 28. Substantially simultaneously, the virtual reseller 32 notifies the credit-risk reducer 28 of the new employed customer 22. The virtual reseller's bank 34 transfers funds to the distributor 30 and to the credit-risk reducer 28 to cover the entire premium for the life of loan. The credit-risk reducer 28 notifies the lender 26 that the loan is insured upon receipt of the funds. The employer 24 then pays the lender 26 by automatic payroll deduction until the loan is paid or the employee 22 leaves the employer's employment. The lender 26 pays monthly accounting fees deducted from the employed customer's 22 installments to the virtual reseller's bank 34. In alternative methods the lender 26 could pay a predetermined fee per transaction or a periodic membership fee unrelated to the actual transaction. The virtual reseller's bank 34, in turn, notifies the virtual reseller 32 when the monthly fees are received.

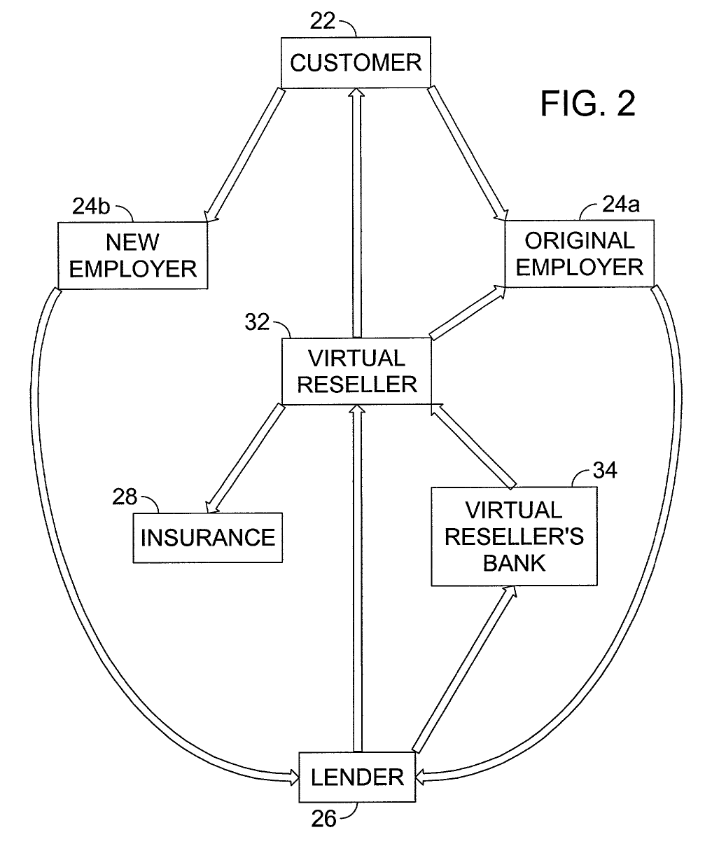

FIG. 2 shows a first exemplary customer job change process of the present invention. In this embodiment the customer 22 fails to notify relevant parties of his termination from the employer 24. Specifically, the employed customer 22 quits or is fired from his job. The original employer 24a stops payroll deductions. The employed customer 22 is hired by a new employer 24b, but does not set up loan payments. The lender 26 stops paying monthly fees for the account and the virtual reseller 32 recognizes that the accounting fee has not been received. At that point, the virtual reseller 32 contacts the original employer 24a about the missed payment. Further, the virtual reseller 32 contacts the customer 22 about potential default by phone and e-mail. The employed customer 22 then asks the new employer's 24a human resources department to set up payroll deduction to the lender 26. The new employer 24b completes the employer's portion of the online loan application form providing the necessary information. Upon receipt of the new application, the lender 26 notifies the virtual reseller 32 of new loan information which the virtual reseller 32 passes on to the credit-risk reducer 28. The new employer 24b resumes loan payments, the lender 26 resumes paying monthly fees, and the virtual reseller's bank 34 notifies the virtual reseller 32 when the monthly fees are received. The virtual reseller 32 recognizes that the payment of accounting fee has resumed and updates the general ledger.

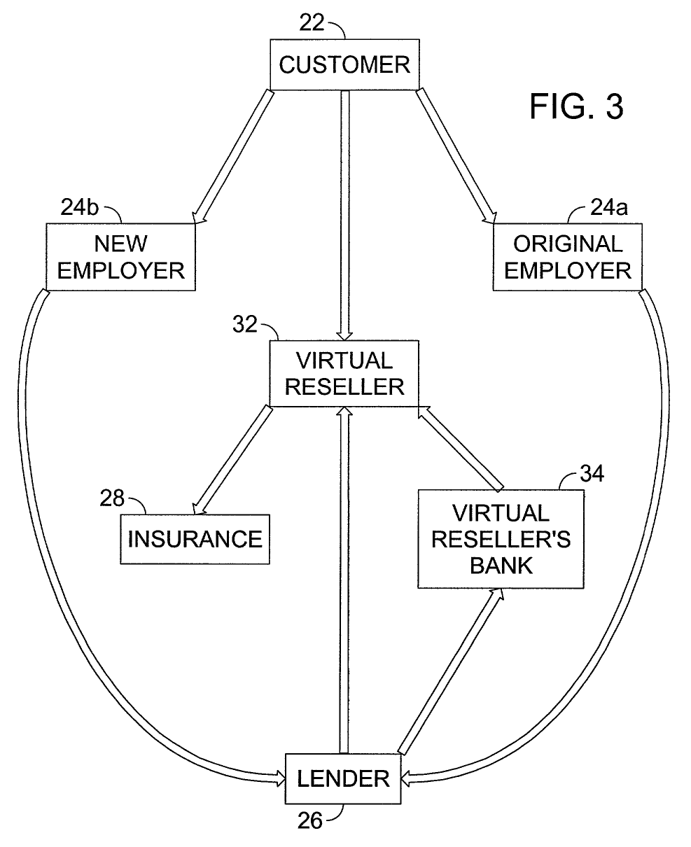

FIG. 3 shows a second exemplary customer job change process of the present invention. In this embodiment the customer 22 does notify relevant parties of his termination from the employer 24. Specifically, the employed customer 22 quits or is fired from his job. The original employer 24a stops payroll deductions. The employed customer 22 then goes to the virtual reseller's 32 web site and prints forms for change of employer. The employed customer 22 then is hired by a new employer 24b and asks the new employer's human resource department to set up payroll deduction to the lender 26. The new employer 24b completes the employer's portion of the online loan application form providing the necessary information. Upon receipt of the new application, the lender 26 notifies virtual reseller 32 of the new loan information which the virtual reseller 32 passes on to the credit-risk reducer 28. The new employer 24b continues to make the loan payments as normal, the lender 26 resumes monthly fee payment, and the virtual reseller's bank 34 notifies the virtual reseller 32 when the monthly fees are received. The virtual reseller 32 recognizes that payment of the accounting fee has resumed and updates the general ledger.

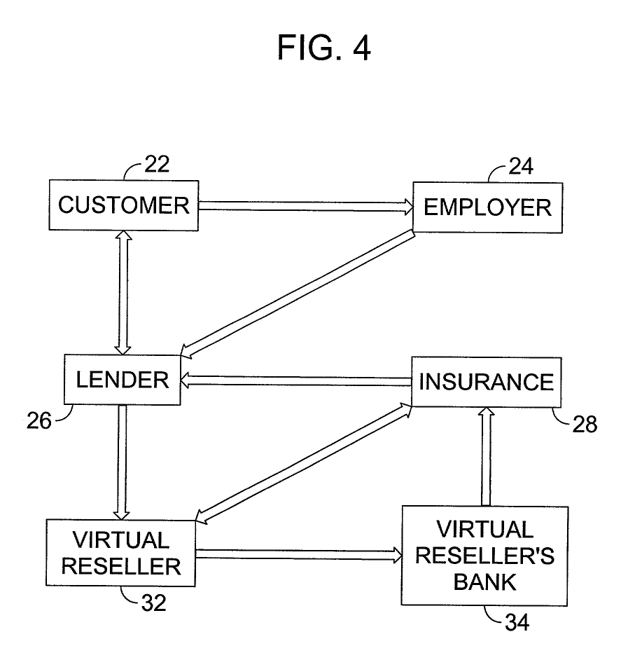

The present invention also anticipates that under certain circumstances the employed customer 22 may wish to extend the period for repayment of the loan. FIG. 4 shows an exemplary loan extension process. Specifically, the employed customer 22 clicks through from the virtual reseller's 32 web site to the lender's 26 web site, and asks for a repayment period extension. The lender 26 approves the repayment period extension and sends new loan documents to the employed customer 22. The employed customer 22 then prints loan documents, takes the documents to his other employer's human resources department, and requests payroll deduction modification. The employed customer 22 mails the signed loan documents to lender 26 and, substantially simultaneously, the employer 24 confirms new terms for the loan and may stop payroll deduction for a specified time. The lender 26 notifies the virtual reseller 32 of the new loan terms and, in turn, the virtual reseller 32 notifies the credit-risk reducer 28 of the new loan term. Upon the credit-risk reducer 28 notifying the virtual reseller 32 of the new premium, the virtual reseller 32 sends instructions to pay an incremental insurance premium and the virtual reseller's bank 34 transfers incremental premium funds. When it receives the funds, the credit-risk reducer 28 notifies the lender 26 that the modified loan is insured.

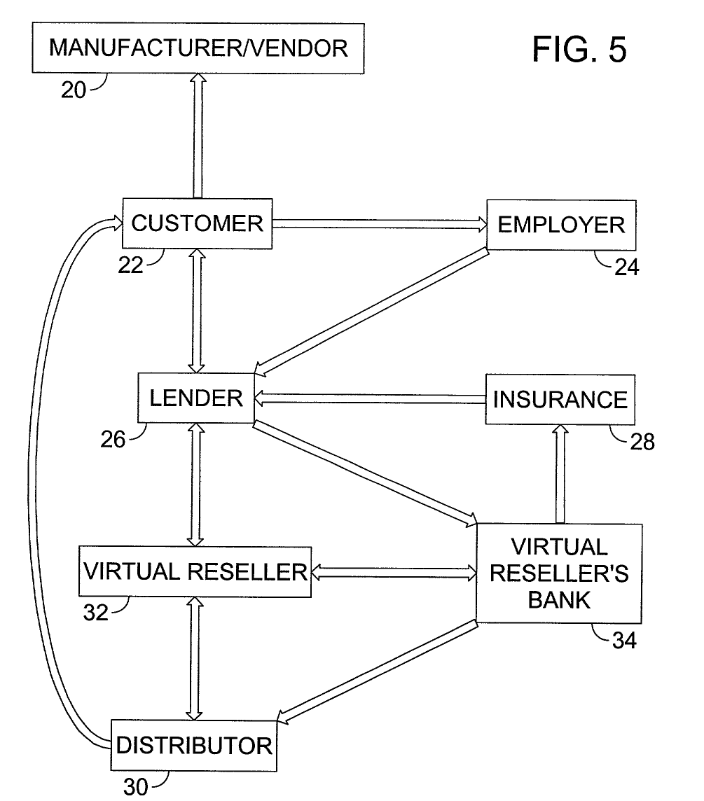

FIG. 5 shows an exemplary process by which an employed customer 22 can purchase additional products. As is apparent, this process is substantially similar to the original process of basic setup and service process shown in FIG. 1. In this process, the employed customer 22 selects additional products at participating manufacturer's 20 online store and picks the Virtual Reseller Credit Program as a financing option. Next, the employed customer 22 submits a loan application at the lender's 26 web site (which may be linked to the manufacturer's 20 web site). The lender 26 then approves the additional products loan and sends loan documents to the employed customer 22 via an electronic communication media. The employed customer 22 may print out the loan documents (or use electronic mechanisms), take documents to his or her employer's 24 human resources department, and request to cancel the previous payroll deduction and set up a new one. The employed customer 22 then mails signed loan documents to the lender 26. Substantially simultaneously, the employer 24 confirms the new terms for the modification of the loan to the lender 26. The lender 26 then sends an approved purchase order and supporting information to the virtual reseller 32. Upon receipt, the virtual reseller 32 sends a purchase order to the distributor 30 who ships the additional products to the employed customer 22. The distributor 30 then sends a shipping confirmation and requests payment from the virtual reseller 32. The virtual reseller 32 then notifies the lender 26 that the additional products have been shipped, and requests payment. The lender 26 then funds the loan for the additional products to satisfy the virtual reseller's 32 purchase order and, upon receipt of funds, the virtual reseller's bank 34 notifies the virtual reseller 32 that the loan has been funded. The virtual reseller 32 then sends instructions to the bank 34 to pay the distributor 30 for the new products and to pay the credit-risk reducer 28. Substantially simultaneously, the virtual reseller 32 notifies the credit-risk reducer 28 of the modifications to the employed customer's 22 policy. The virtual reseller's bank 34 transfers funds to the distributor 30 and to the credit-risk reducer 28 to cover the incremental premium for the increased amount of the loan. The credit-risk reducer 28 notifies the lender 26 that the new loan is insured upon receipt of the funds. The employer 24 then pays the lender 26 by automatic payroll deduction the new amount and/or for an extended period until the loan is paid or the employee 22 leaves the employer's employment. The lender 26 pays monthly accounting fees to the virtual reseller's bank 34 who, in turn, notifies the virtual reseller 32 when the monthly fees are received.

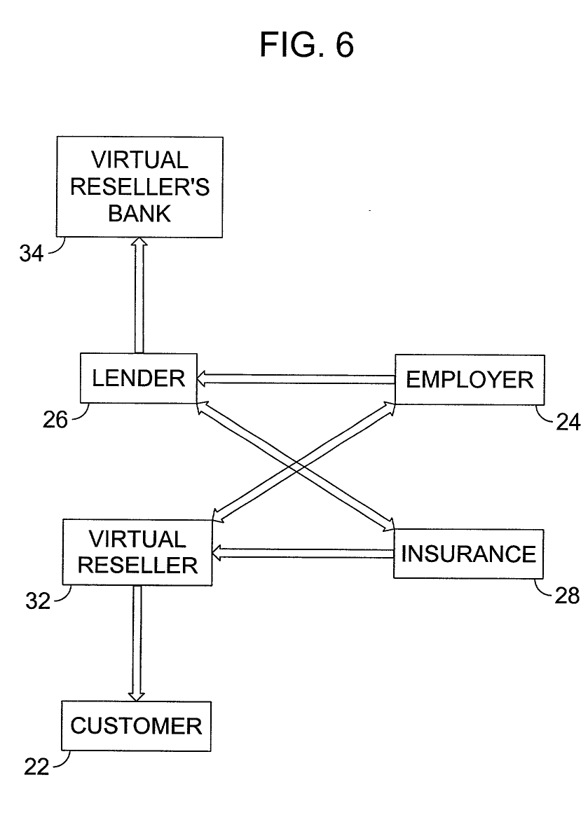

FIG. 6 shows an exemplary embodiment of a process of the present invention that handles an employed customer's 22 loan default. Specifically, the employer 24 stops the automatic payroll deductions. Next, the lender 26 stops paying the monthly fee for the account to the virtual reseller's bank 34. Either the virtual reseller's bank 34 notifies the virtual reseller 32 or the virtual reseller 32 otherwise recognizes that the accounting fee has not been received. The virtual reseller 32 may then contact the employer 24 and/or the customer 22 about missed payment. Contact with the employer 24 and/or customer 22 may be made, for example, electronically (such as by e-mail), by telephone, by postal mail, and/or by personal visits. Preferably either the employer 24 or the customer 22 provides the virtual reseller 32 some explanation for payment stoppage. If the loan is truly in default, the lender 26 notifies the credit-risk reducer 28 that the loan is in default and requests pay-off. In response, the credit-risk reducer pays off the loan. When the loan has been paid off, the virtual reseller 32 removes the customer 22 from any past-due reports, closes the account, and updates the general ledger.

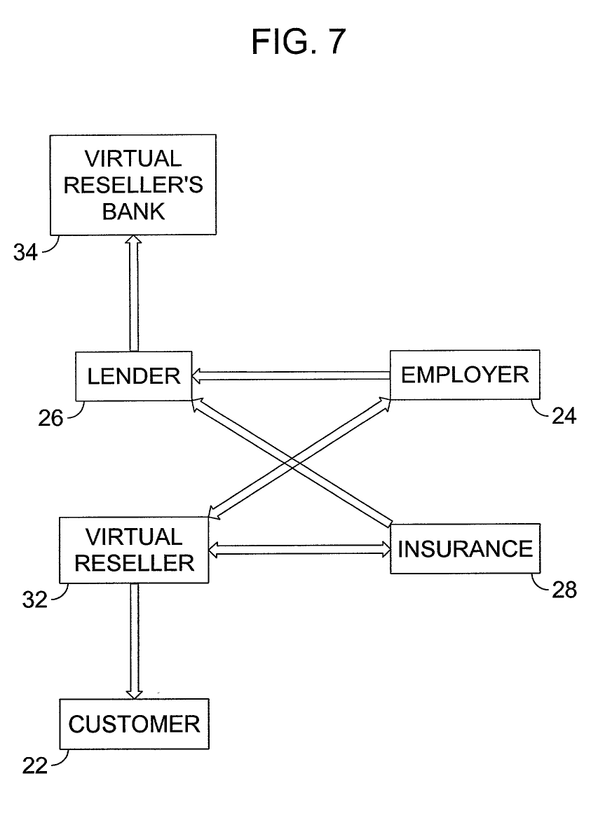

FIG. 7 shows an exemplary embodiment of the coverage process used by the credit-risk reducers or insurance 28 to cover payments missed by the customer 22. First, an insured event such as death, disability, or unemployment occurs. In response to the employed customer's 22 termination of work, the employer 24 stops payroll deductions. In response, the lender 26 stops paying monthly fees to the virtual reseller's bank 34. Either the virtual reseller's bank 34 notifies the virtual reseller 32 or the virtual reseller 32 otherwise recognizes that the accounting fee was not received. This causes the virtual reseller 32 to contact the employer 24 about the missed payment. The virtual reseller 32 also may contact the customer 22 about potential default. Contact with the employer 24 and/or customer 22 may be made, for example, electronically (such as by email), by telephone, by postal mail, and/or by personal visits. The employer 24 and/or customer 22 provides an explanation for the stoppage of the payments. Based on the explanation, the virtual reseller 32 submits claim to have the credit-risk reducer 28 pay the missed payments and the credit-risk reducer 28 makes the payments to the lender 26. The credit-risk reducer 28 also notifies the virtual reseller 32 of its approval to make payments. Receiving its payments, the lender 26 resumes paying the accounting fee to the virtual reseller's bank 34. Either the virtual reseller's bank 34 notifies the virtual reseller 32 or the virtual reseller 32 otherwise recognizes that the accounting fee has resumed and updates the general ledger and otherwise takes appropriate action.

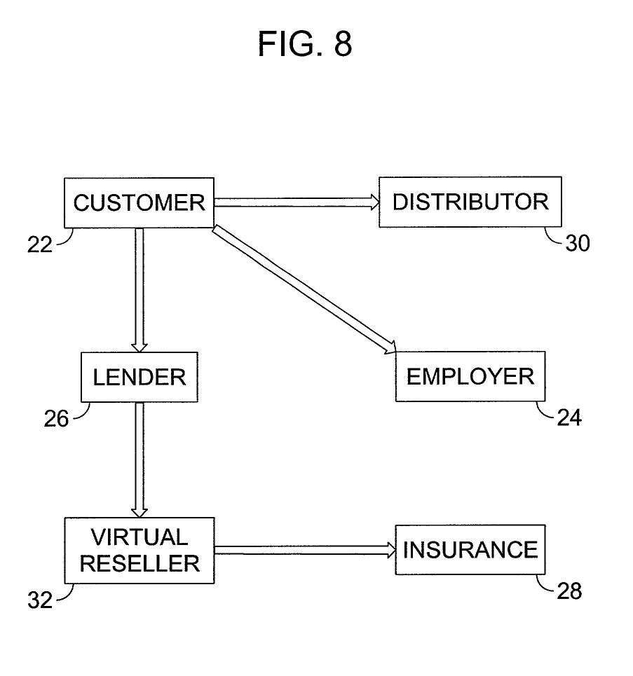

FIG. 8 shows an exemplary embodiment of the process used by an employed customer 22 to update information such as an address change or other non-financial information. First, the employed customer 22 notifies the lender 26 of the changes of information. The lender 26, in turn, notifies the virtual reseller 32 of the changes of information. The virtual reseller 32 then notifies the credit-risk reducer 28 of the changes. If necessary, it would be the employed customer's 22 responsibility to notify distributor 30 (who provides tech support) and the employer 24. It should be noted that in an alternate embodiment the employed customer 22 notifies the virtual reseller 32 directly and the virtual reseller 32 then notifies some or all of the remaining parties.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A method for providing consumer financing, said method comprising the steps of:
(a) receiving a completed credit application on behalf of an employed customer employed by an employer;
(b) determining creditworthiness of said employed customer based at least in part on the reliability factor provided by automatic payroll deductions from said employed customer's employer;
(c) providing a credit-risk reducing feature for grants of credit to said employed customers;
(b) determining creditworthiness of said employed customer based at least in part on said credit-risk reducing feature;
(d) granting credit to said employed customer; and
(e) receiving payments automatically from said employer through automatic payroll deduction from said employer.

2. The method of claim 1 further comprising the step of providing a product to said employed customer.

3. The method of claim 1 further comprising the steps of:
(a) receiving an order for said product on behalf of said employed customer,
(b) purchasing said product from a third party only after said step of receiving said order; and
(c) shipping said product to said employed customer using third party distribution.

4. The method of claim 1 wherein said step of receiving said completed credit application further comprises the step of receiving said completed credit application through electronic communication media.

5. The method of claim 1 further comprising the step of receiving confirmation information from said employer of said employed customer's employment.

6. The method of claim 1 wherein said step of receiving payments automatically further comprises the step receiving payments automatically through payroll deduction via electronic communication media.

7. The method of claim 1 further comprising the step of monitoring repayment of said credit.

8. A Virtual Reseller Credit Program, said program comprising:
(a) at least one employed customer seeking to finance the purchase of a product having a cost;
(b) at least one employer employing said employed customer;
(c) at least one lender for granting credit in the amount of said cost to said employed customer based, at least in part, on said employed customer's employment;
(d) at least one credit-risk reducer for providing said at least one lender repayment of said credit to said lender in the event of said employed customer defaulting; and
(e) at least a portion of said cost being used to fund said credit-risk reducer.

9. The program of claim 8 further comprising automatic payroll deductions from said employed customer's pay being forwarded to said lender by said employer.

10. The program of claim 8 wherein said program is implemented at least in part over electronic communications media.

11. The program of claim 8 further comprising:
(a) a virtual reseller for receiving an order for said product on behalf of said employed customer,
(b) a manufacturer from whom said virtual reseller purchases said product only after said virtual reseller receives said order; and
(c) a distributor for shipping said product to said employed customer.

12. The method of claim 8 further comprising a virtual reseller for monitoring repayment of said credit and automatically detecting late payments.

13. The program of claim 8 wherein said at least one credit-risk reducer is credit insurance.

14. The program of claim 8 wherein said at least one credit-risk reducer is a recourse reserve fund.

15. A method for consumer financing being implemented at least in part using electronic communication media, said method comprising:
(a) providing a credit-risk reducing arrangement for grants of credit for at least one employed customer who otherwise would not qualify for traditional credit;
(b) confirming that said at least one employed customer's employer is willing to make automatic payroll deduction payments on behalf of said at least one employed customer;
(c) granting credit to said at least one employed customer based on said at least one employed customer's employment status and said credit-risk reducing arrangement; and
(c) receiving payments automatically through payroll deduction.

16. The method of claim 15 further comprising the step of funding at least a portion of said credit-risk reducing arrangement using a portion of said payments.

17. The method of claim 15 further comprising the step of providing said product to said employed customer by directing a third party to provide said product to said employed customer.

18. The method of claim 15 further comprising the step of monitoring installment payment flow and automatically detecting late payments.
